(19) United States
(12) Patent Application Publication
(10) Pub. No.: US 2026/0283098 A1
(43) Pub. Date: Sep. 24, 2026

(54) Pellet Pal Litter System

(71) Applicant: Thomas Tyler, Pocomoke City, MD (US)

(72) Inventor: Thomas Tyler, Pocomoke City, MD (US)

(21) Appl. No.: 19/570,262

(22) Filed: Mar. 18, 2026

Related U.S. Application Data
(60) Provisional application No. 63/774,410, filed on Mar. 19, 2025.

(51) Int. Cl. A01K 1/01

(52) U.S. Cl. CPC A01K 1/0114

(57) ABSTRACT

A litter box system for disintegrating pellet litter including a top sifter pan which holds the pellets and which has a plurality of holes through which cat urine may flow and pellet sawdust is sifted. The top pan is supported in a bottom pan by ridges on the sides of the bottom pan. The bottom of the bottom pan is indented upwards to form a channel which runs around the perimeter of the bottom which holds a further quantity of fresh pellets, as well as sifted pellet material from the top pan. The design allows the litter box system to retain completely vertical outer walls and a square profile. The depth of the bottom pan allows for long collection periods during which the litter box system need not be emptied and it raises the height of the litter box system for easier cleaning access.

### CROSS-REFERENCE TO RELATED APPLICATIONS

U.S. Provisional Patent Application No. 63/774,410 filed on Mar. 19, 2025

### PRIOR ART

U.S. Pat. No. 11,129,356 B2 dated Sep. 28, 2021

JP 5651432 B2 dated Nov. 9, 2010

U.S. Pat. No. 5,755,182 dated May 26, 1998

U.S. Pat. No. 11,793,155 B2 dated Oct. 24, 2023

United States Patent Application Publication No. US 2023/0051699 A1 filed on Nov. 2, 2022

CN 206212936U U dated Nov. 21, 2016

CN 214257548U U dated Jan. 8, 2021

U.S. Pat. No. 5,363,808 dated Nov. 15, 1994

U.S. Pat. No. 6,941,894 B2 dated Sep. 13, 2025

U.S. Pat. No. 11,540,486 B2 dated Jan. 3, 2023

United States Patent Application Publication No. US 2008/0314328 A1 filed on Jun. 22, 2007

United States Patent Application Publication No. US 2012/0318204 A1 filed on Oct. 4, 2010

United States Patent Application Publication No. US 2025/0040509 A1 filed on Oct. 18, 2024

### BACKGROUND OF THE INVENTION

Pine pellet cat litter has been growing in popularity amongst cat owners for many reasons, but there are few litter box—related products on the market designed for use specifically with pine pellets. This means that currently, there is a very large and untapped market demand for pine pellet—focused litter systems. Most cat owners are still using traditional clumping litter. Usually, this litter is made of some form of clay. This type of litter, and the maintenance involved with it, is the most unappealing part of owning an indoor cat. When clay litter is poured into a litter box or when cats use the litter and it is agitated or disturbed, it creates high amounts of dust that can lead to allergy, digestive tract and/or respiratory issues in both the pet and its human family members. The dusty clay litter is often fragranced as well and when the dust sticks in the cat's fur, the animal will smell like the litter box. There is a slew of respiratory and digestive health issues that a cat can contract by accidentally ingesting the litter or dust while simply using the litter box, or whilst grooming itself. The small particle size of traditional clumping litter also leads to heavy tracking outside of the litter box. When a cat defecates in a litter box, traditional cat litter does not sufficiently clump around the stool; especially loose stool. When a cat urinates on traditional litter, the litter creates clumps which must be removed from the litter box simultaneously with the fecal matter. The small, easily tracked particles make keeping the litter box area clean difficult, especially in homes with multiple cats. Furthermore, “clumping” cat litters don't always do the best job of clumping up urine and loose stools. This leads to heavily urine-saturated litter that feels more like dense and heavy mud than a dry clump, and loose stools often get encrusted on the outside but remain soft on the inside. Obviously, this makes cleaning the litter box an often lamented and dreaded household chore. It should also be noted that a single cat can create hundreds of pounds of waste per year from clumping litter and this waste does not effectively break down in landfills for hundreds of years. Finally, the clay used in traditional cat litters is often sourced from strip mines that are environmentally harmful.

The use of pine pellets as cat litter is well known in the art. Humane societies and animal shelters have been using pine pellets as litter for years. Two of the main reasons for such use are the extremely low cost and minimal odor of pine pellets compared to traditional dusty, clumping cat litter. The use of compressed/dried pine pellets solves virtually all of the negative issues involved with using traditional clay litter. Pine pellets create very little, to virtually no dust. Without this dust, a cat's fur will not smell like litter and the cat will not ingest harmful dust whilst grooming itself. The larger size and weight of the pine pellets means that there will be virtually no tracking of litter outside of the litter box, as compared to traditional litter. When pine pellet litter is tracked outside of the litter box however, it is easily cleaned, as the tracked pellets are kept within the immediate range of the litter box simply due to their larger size and weight. Whenever liquid/urine comes into contact with the pine pellets and the pellets absorb the moisture, they expand and fall apart into sawdust. The pellets also dehydrate and adhere to any feces or loose stools, essentially performing a more effective version of the “clumping” action of traditional litters. This eliminates the creation of muddy piles of urine or pellet-encrusted (but still soft) loose stools. Pine pellets are also much cheaper than traditional clay cat litter. Finally, pine pellets exude a natural and pleasant pine scent, as opposed to an unnatural scented or perfumed smell, so there are no unnatural fragrances, dust or particles for the cat to ingest or respirate, leading to a healthier animal. Cats are very adept at hiding pain, suffering, and disease so eliminating as many potential health or allergy risks as possible is desirable. Additional advantages of using pine pellets for litter include the fact that the sawdust created by the breakdown of pellet litter can be used for rodent control. It can also be composted or used in undiluted form to control plant and weed growth. It can be used in diluted form to help adjust soil pH and soil fertility.

Pine pellets may be a great solution for cat litter, but pine pellets do not work well when used with existing traditional litter box systems. This is simply because traditional litter box systems are not designed to specifically play into the strengths that pine pellets naturally offer as litter material. A traditional litter box is just a single deep pan that holds litter. If pine pellets are used in this type of box, the urine breaks the pellets down into dust and the pellets dehydrate the feces. The cats naturally mix these materials up when they use the litter box. This leads to a litter box that is full of multiple forms of materials that need to be sifted when cleaning time comes: the dust, the feces and the unused pellets. If a traditional litter scooper is used, it allows the dust to fall through, but it does not separate the feces and solid waste from the unused pine pellets and the user is left with a scooper full of pristine pellets along with solid waste. Thus, with a traditional litter box, the user would first have to sift out all the dust so that it can be disposed of, and second, the user would need to sift the remaining pellets and solid waste mixture in order to separate the stool from the unused pine pellets so as to ensure that clean pellets are not discarded. As this two-phase procedure is time consuming, many owners simply empty the entire litter box and refill it with fresh pine pellets whenever the litter becomes too messy, which is obviously wasteful.

The mixture of feces, sawdust, and unused pellets that build up in a traditional litter box system using pine pellets results in messy conditions inside the litter box, which leads to more tracking of material outside the litter box and pine pellet wastage. Litter box designs with only one box, or pan, allow the buildup of broken-down pine pellet sawdust which cats necessarily step into each time they enter the litter box, and they end up tracking the litter out of the box. A traditional litter box system and litter scooper does not offer any design features focused on fixing these issues, which makes pine pellets more of a hassle to use in traditional litter box systems regardless of their benefits. This remains a barrier to entry for most cat owners when it comes to using pine pellets as their main source of litter. Currently, there is a lack of litter systems on the market that are specifically designed to work with the natural, beneficial properties that pine pellets offer as litter material.

There are some two-pan litter box systems on the market that can be used with pine pellets, but they are not designed specifically to work with the natural characteristics of pine pellets in the manner of the present invention. The two-pan litter box systems on the market often use less environmentally friendly, messy pee pads or bin liners in the bottom pans, which are not required in the present invention. Two-pan litter box systems on the market which can be used with pine pellets do not allow entire pine pellets to drop into the bottom pan and they do not have a channel around the perimeter of the bottom pan in which additional, new pellets can rest which soak up the urine that cats deposit there while engaged in their typical behavior of urinating around the perimeter of the litter box systems. The two-pan systems on the market do not have large storage pans, they do not have a raised portion in the bottom pan to limit pellet wastage, they are not significantly raised from the ground for improved ergonomics while cleaning or for reducing litter tracking and they are not designed to nest while retaining vertical walls and a more square overall profile, lacking negative space where materials can become caught, which results in the ease of cleaning and maintenance. Additionally, these box systems lack the long-term storage capacity of the present invention even if they offer initial pellet-filtration action.

### SUMMARY OF THE INVENTION

The present invention is an extremely simple yet efficient design which provides significant advantages over traditional litter box systems. This system is designed for pine pellets or any other pellet-type cat litter which breaks down into sawdust when exposed to cat urine, or urine of any small, domesticated animal. The system is comprised of two pans constructed of plastic, metal or any rigid structural material, a top pan shallow in depth and a bottom pan deeper in depth, the top pan nesting inside the bottom pan. The shallow top pan (the “Sifter pan”) is where fresh litter is kept and where cats urinate/defecate. The floor of the Sifter pan is perforated with a plurality of evenly spaced holes that allow any pellets that have absorbed moisture and have broken down into sawdust to fall through and into the bottom, deeper pan (the “Collection Pan”). When the cats dig in the Sifter Pan of the litter box system and when the Sifter pan is scooped, the digging/sifting/scooping action motivates the sawdust, and some unused pellets, to fall through the holes while the vast majority of the unused pellets remain in the Sifter pan. There are also unique, angled slits around the bottom perimeter of the Sifter pan (the “Urine Guiding Slits”) which direct urine down the sides of the Collection Pan and into the deep channel at the perimeter of the Collection Pan floor (the “Urine Collection Channel”) which contains additional, fresh pellets.

The Collection Pan captures and stores the sawdust. Additional fresh litter is placed in the Urine Collection Channel. The greater depth of the Collection Pan results in a less frequent need to empty used litter out of the system because the depth allows for weeks of storage for used pellet sawdust. The owner can wait until the Collection Pan is entirely full to empty it, if necessary. Since cat urine is absorbed by the pine pellets, causing the resultant moisture-affected sawdust to fall through the Sifter pan to be stored in the Collection Pan, this means that while scooping the litter from the Sifter pan, the user will not need to scoop urine-affected litter. Only fecal waste must be scooped out of the Sifter pan. This significantly reduces the amount of work and time it takes to clean and care for the litter box system. When the bottom Collection Pan is emptied of used litter and reset for use, the Collection Pan and Urine Collection Channel can be prefilled with already existing pellets from the Sifter pan. Then the Sifter pan can be refilled with new fresh pellets. As animals use the litter box system, used pellet sawdust falls through the Sifter pan to the Collection Pan and this action, paired with the cycling of pellets from the Sifter pan to the Collection Pan, keeps the pellets in the Sifter pan cleaner and fresher while simultaneously reducing pellet litter waste from the litter box system.

Cats have a tendency to urinate around the perimeter and along the walls of a litter box. The unique Urine Guiding Slits in the Sifter pan will direct the majority of urine produced by pets into the Urine Collection Channel in the Collection Pan. This Urine Collection Channel accommodates a quantity of unused pellets in the place where cat urine would normally be concentrated, around the perimeter of the Collection Pan. This is a significant advantage over flat-bottomed pans in other litter box systems. This reserve of pellets soaks up the excess urine that is not absorbed by pellets in the Sifter pan and it prevents liquid urine build up or excessive ammonia in the Collection Pan. The overall design of the present invention allows it to retain a square shape with vertical walls in order to eliminate any negative space that can collect pellets and animal waste, especially between multiple pans, as in other litter box systems.

The Sifter pan and the Collection Pan in the present invention may also have fill line indicators to guide a user as to the optimal pellet refill level after cleaning. The present invention may also incorporate a ramp or steps to allow animals easy access to the Sifter pan. The present invention may also incorporate a lid to cover the Sifter pan which may also be flipped over and used to hold the Sifter pan during cleaning. Additionally, this lid can be filled with pellets and the top Sifter pan can be placed directly onto the pellet-filled lid which reduces the height of the litter system and removes the storage capacity of the bottom Collection Pan, but makes the litter system more accessible and easy to use when litter-training kittens or other small domesticated animals.

### BRIEF DESCRIPTION OF DRAWINGS

FIG. 1 depicts a cross-sectional, exploded view of the litter box system seen from the front.

FIG. 2 depicts a cross-sectional view of the litter box system seen from the front with the two pans nested together.

FIG. 3 depicts a cross-sectional view of the litter box system seen from the side with the two pans nested together

FIG. 4 depicts a cross-sectional view of the litter box system seen from the front with the two pans nested together containing pellets.

FIG. 5 depicts a cross-sectional view of the litter box system seen from the side with the two pans nested together containing pellets.

FIG. 6 depicts an isometric exploded view of the entire litter box system.

FIG. 7 depicts an external view of the Sifter Pan from the front.

FIG. 8 depicts an external view of the Sifter Pan from the side.

FIG. 9 depicts a cross-sectional view of the Sifter Pan from the side.

FIG. 10 depicts an external view of the Collection Pan from the front.

FIG. 11 depicts an external view of the Collection Pan from the side.

FIG. 12 depicts a cross-sectional view of the Collection Pan from the side.

FIG. 13 depicts a top-down view of the Sifter Pan.

FIG. 14 depicts a top-down view of the Collection Pan.

FIG. 15 depicts a front view of the litter box system covered by the Lid.

FIG. 16 depicts the Sifter Pan placed into the inverted Lid Basin for cleaning.

FIG. 17 depicts an exploded view of the Sifter Pan with fresh pellets placed into the inverted Lid Basin for use with training smaller animals.

FIG. 18 depicts a front view of the invention with Steps added to the Collection Pan.

FIG. 19 depicts a side view of the invention with Steps added to the Collection Pan.

FIG. 20 depicts an exploded isometric view of the pellet litter system with steps.

FIG. 21 depicts a front view of the invention with Steps added to the Collection Pan and the Topper

### DETAILED DESCRIPTION OF THE INVENTION

Herein follows an overall understanding of the principles of the structure, function, manufacture and use of the systems, methods and devices comprising the invention. One or more examples are presented herein and depicted in the accompanying figures. Those skilled in the art will understand that the systems, methods and devices described herein are non-limiting examples and that the scope of the present disclosure is not defined solely by the claims, if any, presented here. The features illustrated or described in connection with one embodiment of the invention may be combined with the features of other embodiments. Such modifications and variations are intended to be included within the scope of the present disclosure.

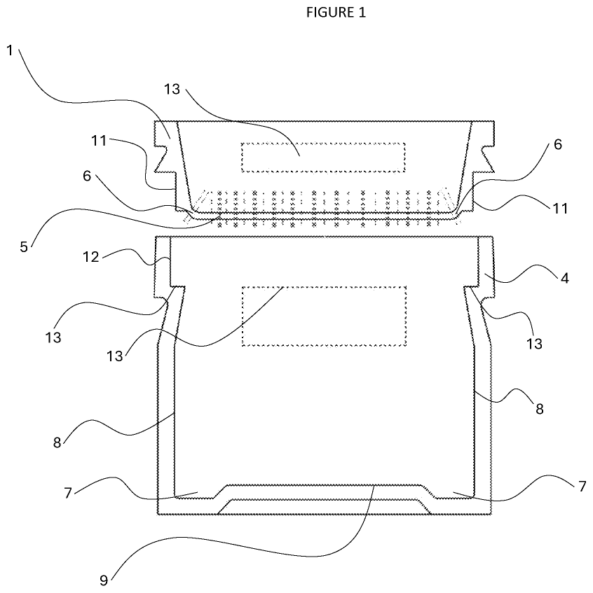

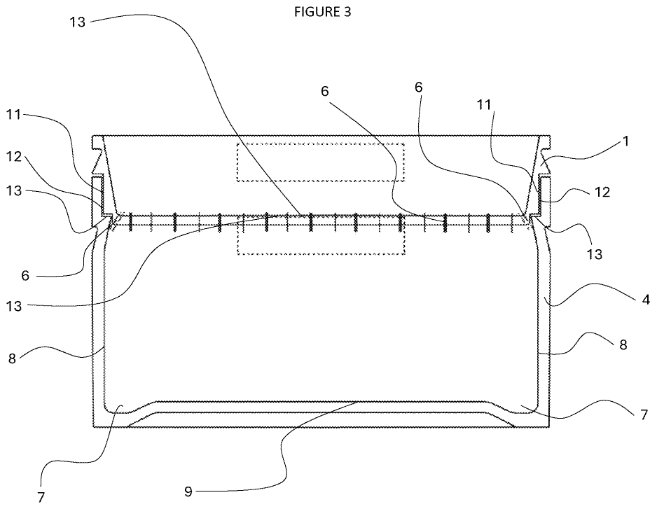

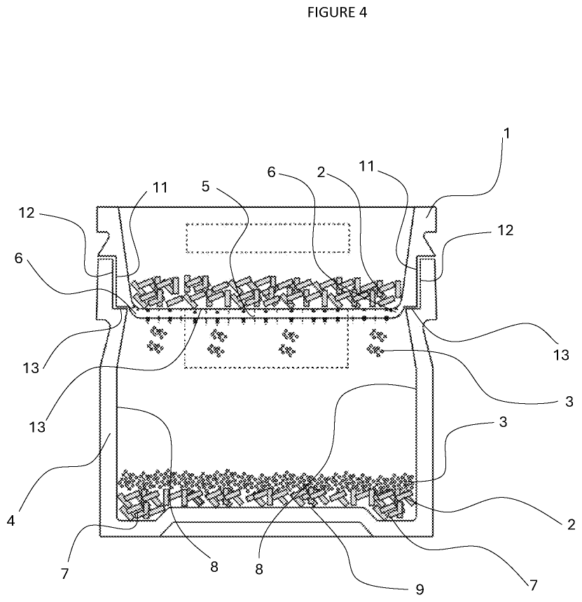

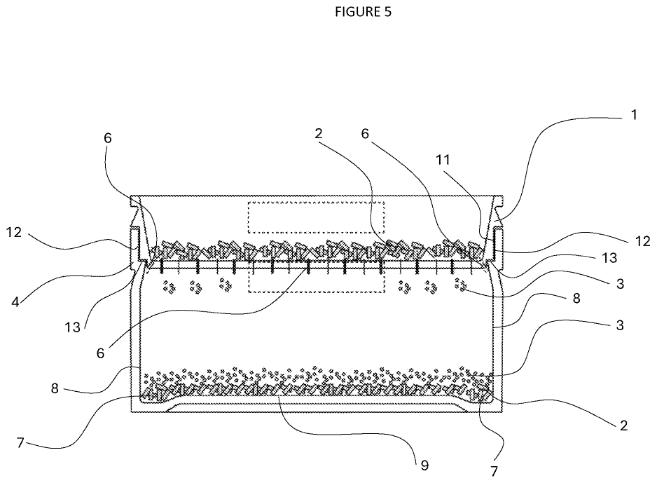

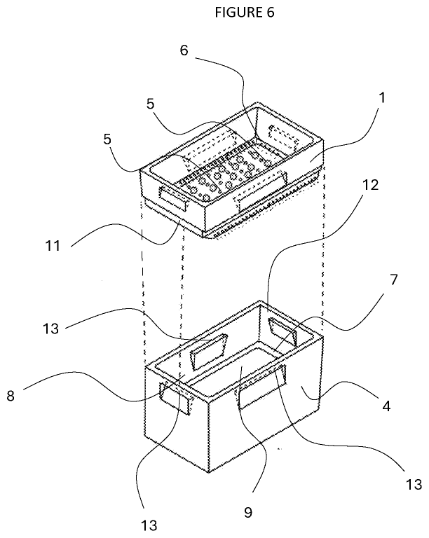

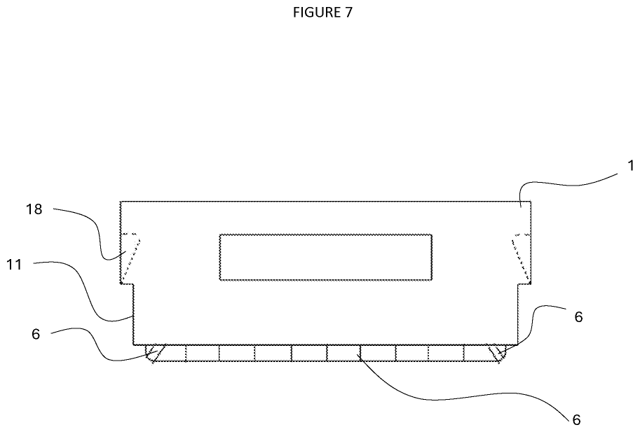

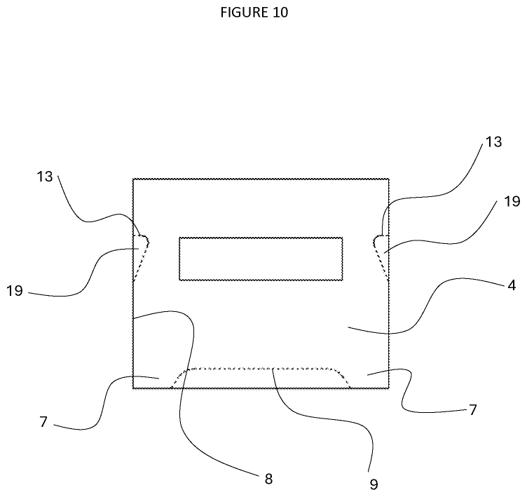

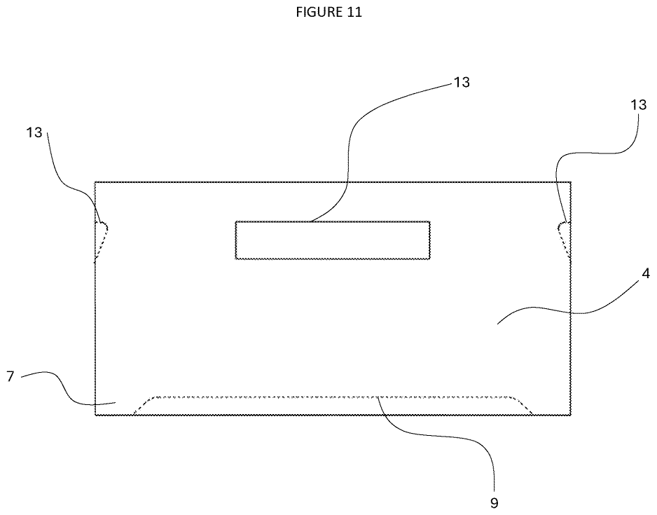

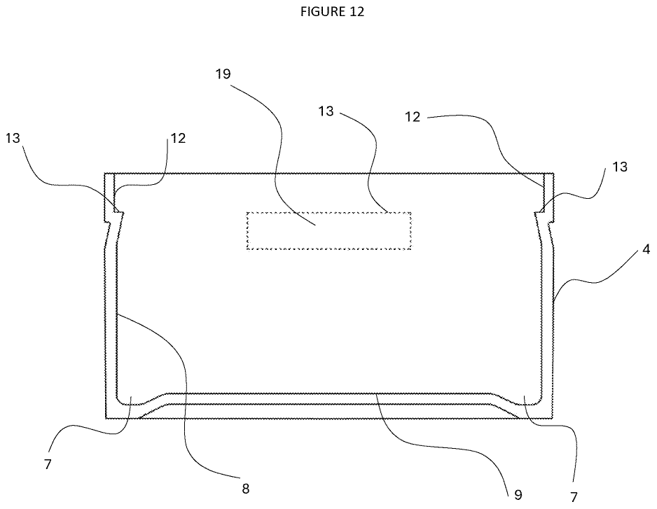

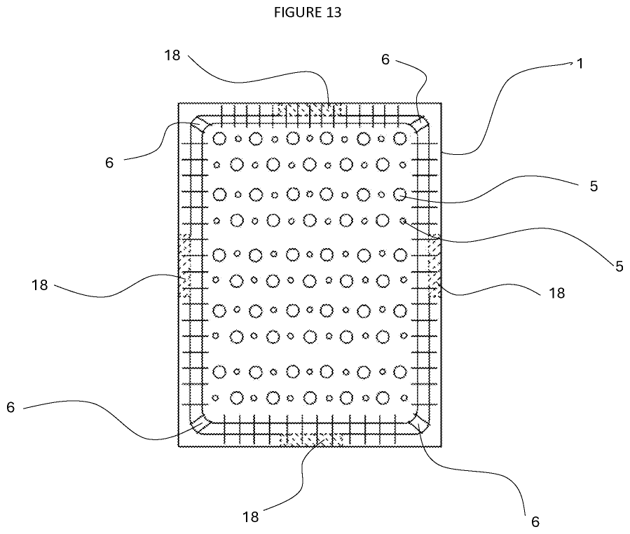

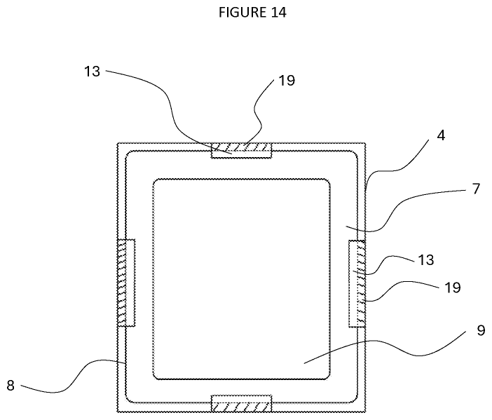

FIGS. 1, 2, 3, 4, 5 and 6 depict the present invention in cross-section and exploded isometric views. The Pellet Pal Litter System includes a top Sifter pan 1 (as depicted in FIGS. 1-9 and 13) to hold pine pellet litter 2, or any similar pelletized litter which tends to break down into sawdust 3 when it encounters liquid, nested into a bottom Collection Pan 4 (as depicted in FIGS. 1-6, 10-12 and 14) which receives the Sifter pan 1 and which collects used pellet material in sawdust 3 form, as well as cat urine. FIGS. 4 and 5 depict the litter system containing the pellet litter 2 and sawdust 3. The Sifter Pan 1 and the Collection Pan 4 are of such a size and height when nested that a cat, or other small, domesticated animal, can easily leap up into the Sifter Pan 1 to use the litter box system.

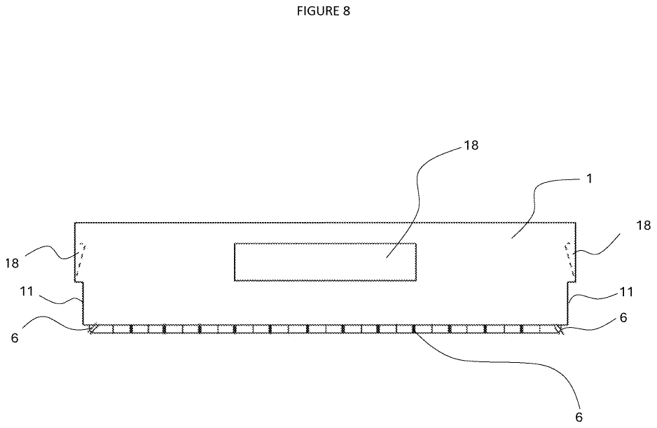

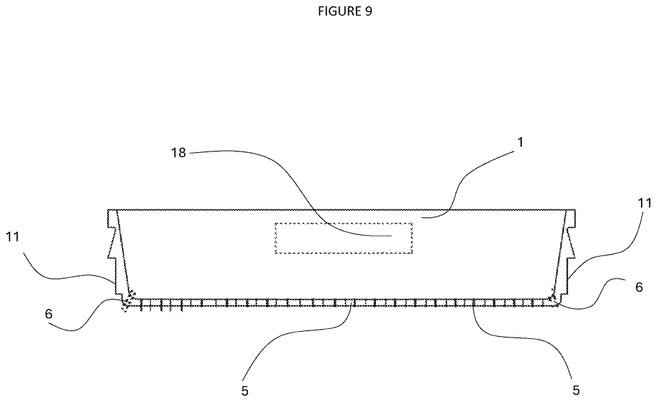

The sides of the Sifter Pan 1 are of a sufficient height to keep the pellet litter 2 from falling out of the Sifter pan 1 due to normal movement of a cat or other small, domesticated animal, as can be seen in FIGS. 4 and 5. The bottom of the Sifter Pan 1 is perforated with an evenly spaced plurality of holes 5 extending therethrough for used pellet litter material in sawdust-like form 3 to sift down through the holes 5 into the Collection Pan 4, as can be seen in FIG. 4. These holes 5 are ideally alternating in size between ¼ inch and 5/16 inch in diameter, as can be seen in FIG. 9, as well as countersunk on the upward facing side of the Sifter Pan 1 to permit efficient sifting of the sawdust 3. The inclusion of the larger diameter holes 5 allows unused, fresh pellet litter 2 to occasionally fall through and into the Collection Pan 4 which serves to keep any offensive odors from emanating from the Collection Pan 4 to a minimum. The angled Urine Guiding Slits 6 around the perimeter of the bottom of the Sifter Pan 1 serve to direct cat urine into the unique Urine Collection Channel 7 at the bottom of the Collection Pan 4, as seen in FIGS. 8, 9 and 15.

The bottom Collection Pan 4 is of an even overall width and length with the Sifter Pan 1. The Collection Pan 4 is at least double the height of the Sifter Pan 1. The Collection Pan 4 has a Urine Collection Channel 7 which runs around the perimeter of its bottom into which additional unused/fresh pellet litter 2 is placed so as to soak up any urine that runs down the Collection Pan's 4 interior walls 8. As seen in FIG. 4, the raised floor 9 of the Collection Pan 4, the perimeter of which is defined by the Urine Collection Channel 7, collects used pellet litter in sawdust-like form 3 which sifts down from the Sifter Pan 1 as well as, from time-to-time, unused pellet litter 2 which falls through the larger holes 5 in the Sifter Pan 1 bottom. The middle of the floor 9 of the Collection Pan 4 is raised above and higher than the Urine Collection Channel 7. When fresh pellets are added to the Urine Collection Channel 7, this raised center section 9 also limits the wastage of pellets which would otherwise be necessitated by filling the entire Collection Pan 4 if it had an entirely flat bottom.

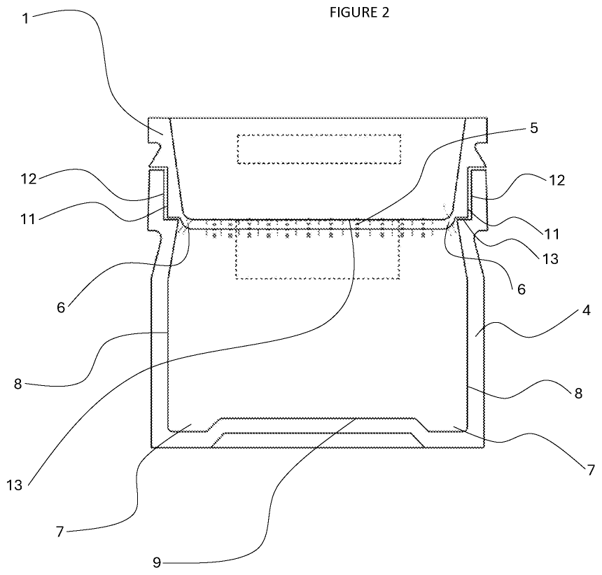

Nesting of the Sifter Pan 1 and the Collection Pan 4, as seen in FIG. 2, is achieved by forming the outer walls of the bottom 11 of the Sifter Pan 1 fractionally smaller than the inner walls 12 of the top of the Collection Pan 4 in such a manner as to have a length and width of the outer walls of the bottom section 11 of the Sifter Pan 1 that are fractionally smaller than the corresponding length and width of the Collection Pan's 4 inner walls 12, thus allowing the Sifter Pan 1 to slide easily into the Collection Pan 4. Both the Sifter Pan 1 and the Collection Pan 4 have angled indentations 13 which serve as handles by which each pan, or the entire litter box system, may be lifted and carried. The tops of the angled indentations 13 in the Collection Pan 4 also serve as nesting ridges (“Sifter Pan Nesting Ridges”) for the Sifter Pan 1 which suspend the Sifter Pan 1 well above the used, broken-down sawdust 3 which collects in the Collection Pan 4 as animals use the litter box system. The interior walls of the Sifter Pan 1 and Collection Pan 4 are smooth so that no litter 2, fecal matter or urine adhere thereto.

As can be seen in FIG. 2, when the Sifter Pan 1 is nested into the Collection Pan 4, the unique angled Urine Guiding Slits 6 in the perimeter of the bottom of the Sifter Pan 1 will sit below the Sifter Pan Nesting Ridge, so no urine will accumulate there. The interior sides of the Sifter Pan 1 are canted at such an angle so as to guide a stream of urine contacting the sides down to the plurality of Urine Guiding Slits 6 evenly spaced around the perimeter of the Sifter Pan 1 at the point where the interior side of the Sifter Pan 1 meets the bottom of the Sifter Pan 1. These Urine Guiding Slits 6 are canted at such an angle so as to direct the urine against the interior wall 8 of the Collection Pan 4 so that it runs down into the Urine Collection Channel 7 in the Collection Pan 4. However, urine will also drip straight to the bottom through the holes 5 in the bottom of the Sifter Pan 1 if an animal urinates toward the center of the Sifter Pan 1, causing the liquid to come into contact with the fresh pellet litter 2 which has fallen through the larger holes 5 in the bottom of the Sifter Pan 1 on the raised floor 9 of the Collection Pan 4, where it will be absorbed. The smooth sides of the Collection Pan 4 are also conducive to the emptying and cleaning of the present invention, as the waste material will slide out without getting trapped on any opposing angles or ledges.

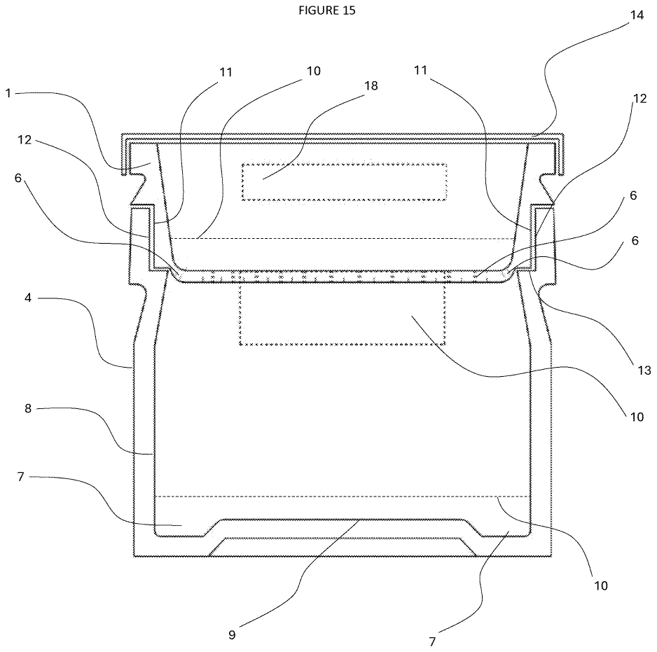

In another embodiment of the invention, a fill line 10 may be included in either the Sifter Pan 1 and/or the Collection Pan 4, as shown in FIG. 15, to guide the user to fill either pan with pellets to the optimal level after cleaning.

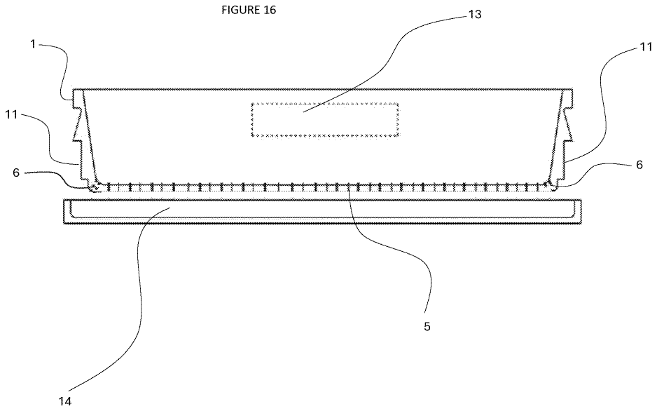

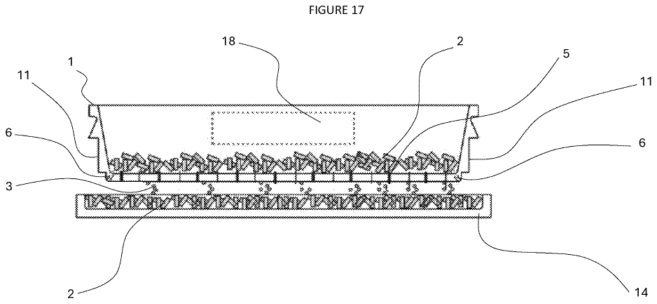

In another embodiment of the present invention the system can also incorporate a plastic lid with a vertical rim around the perimeter 14 (a “Lid Basin”) that can be used to cover the litter box system for storage as depicted in FIG. 15, or which can sit under the bottom Sifter Pan 1 during cleaning so that the Sifter Pan 1 does not have to touch a floor or rug, as shown in FIG. 16. Finally, the Lid Basin 14 may be filled with fresh pellet litter 2 and the Sifter Pan 1 can be placed on top of the litter 2 in the Lid Basin 14 to temporarily create a lower-profile litter box system for the training of young pets, as depicted in FIG. 17.

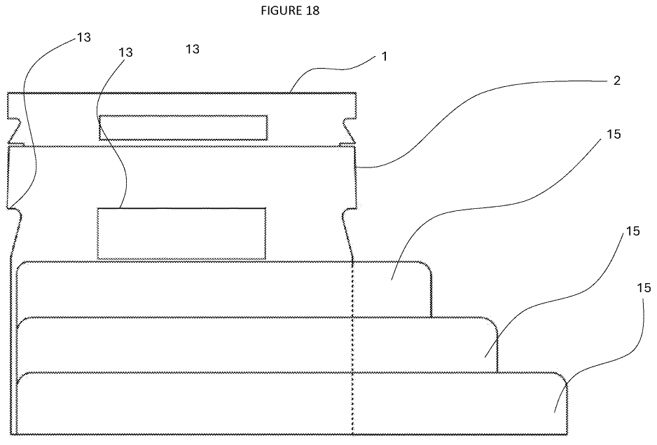

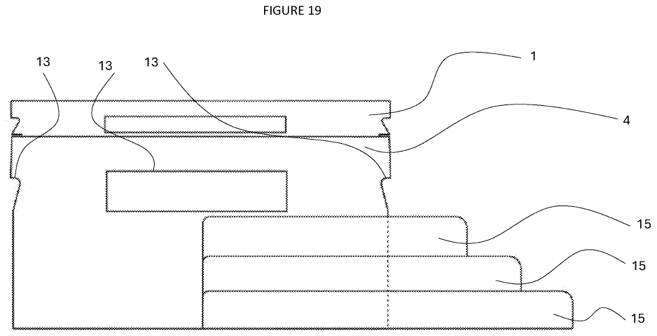

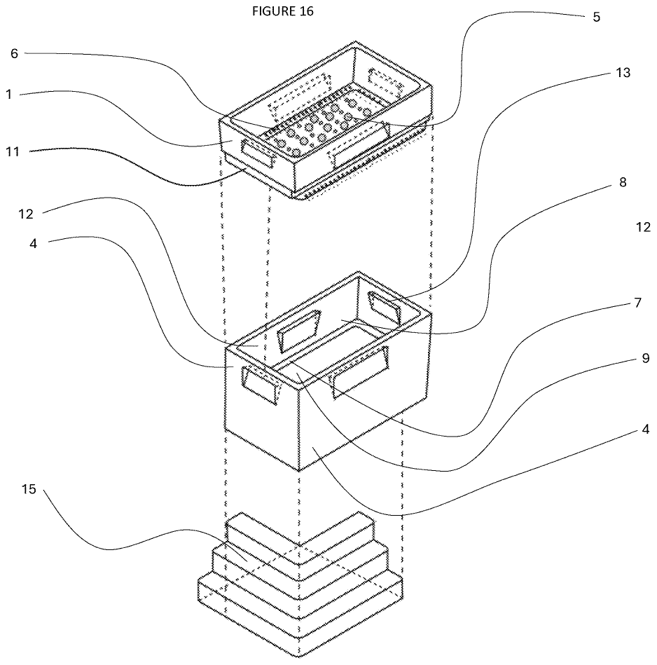

In another embodiment of the invention, an angled ramp or steps 15 (“Steps”) may be affixed to the side of the Collection Pan 4 which may be used by smaller or less agile animals to ascend to the Sifter Pan 1. FIG. 18-21 depict the embodiment of the invention incorporating the Steps 15 feature in various views.

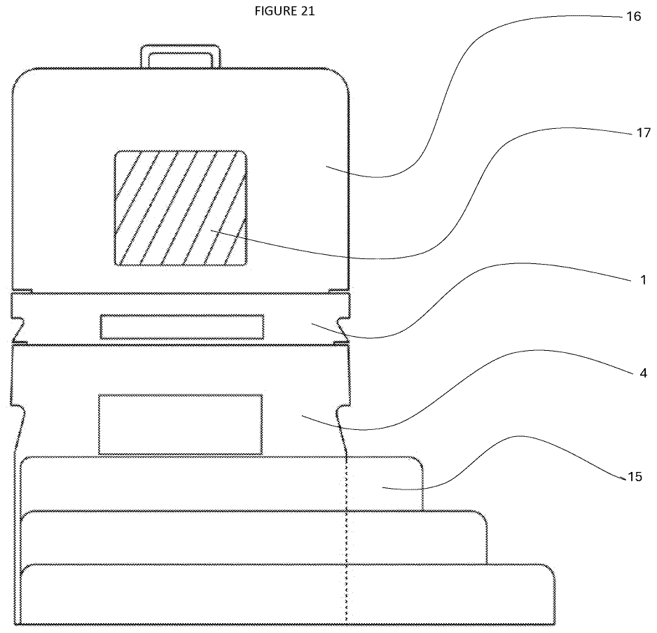

In yet another embodiment the invention which incorporates the Steps, any shape of “topper” type structure 16 (a “Topper”) can be included to sit upon the Sifter Pan 1 which will cover the litter system, as depicted in FIG. 21, and provide more protection against pellet spillage and tracking. The Topper 16 will have an entrance 17 of any typical orientation which will enable animals to enter the Sifter Pan 1. The Topper 16 can be fitted with flap style doors covering the entrance 17 that are currently commonplace amongst other litter box systems.

1. A nestable small animal litter box system for use with a disintegrating-type pelletized cat litter comprising:
a bottom collection pan, the bottom collection pan including a raised center floor forming a channel around the perimeter of the floor, vertical walls which are of sufficient height to accommodate a sufficient quantity of pellet litter, and with indentations in each wall which protrude into the collection box,
a top sifter pan of the same horizontal dimensions as the collection pan with slightly smaller dimensions around its bottom than the inner walls of the bottom collection pan such that it sealingly abuts and frictionally fits together with the inner walls of the bottom of the collection pan and which nests inside the bottom collection pan suspended above the pelletized litter in the bottom collection pan while resting on the indentations in the walls of the bottom collection pan, the top sifter pan bearing a plurality of perforations in its floor of varying sizes, both smaller and larger than the disintegrating-pellet litter and bearing a plurality of angled slits around the perimeter of the top sifter pan's bottom at the interface between the side walls of the top sifter pan and the bottom of the top sifter pan.

2. The nestable small animal litter box system of claim 1 whereby steps abut the bottom collection pan to aid small animals in reaching the top sifter pan.

3. The nestable small animal litter box system of claim 1 whereby a ramp abuts the bottom collection pan to aid small animals in reaching the top sifter pan.

4. The nestable small animal litter box system of claim 1 whereby a lid of sufficient size to cover the pellet box is included.

5. The nestable small animal litter box system of claim 1 whereby a closed top of sufficient size to enclose the top sifter pan and which rests on the top sifter pan and which has a hole in the side to allow ingress/egress is included.

6. The nestable small animal litter box system of claim 1 whereby marks are included in the inner sides of the top sifter pan to demonstrate the optimal amount of pellet material to fill the top sifter pan.

7. The nestable small animal litter box system of claim 1 whereby marks are included in the inner sides of the bottom collection pan to demonstrate the optimal amount of pellet material to fill the bottom collection pan.
